(19) United States
(12) Patent Application Publication
(10) Pub. No.: US 2012/0031929 A1
(43) Pub. Date: Feb. 9, 2012

(54) Dual-use type grease gun

(75) Inventor: Wen-I Guo, TAIPIN CITY (TW)

(73) Assignee: SUCTION INDUSTRIAL CO., LTD., TAIPIN CITY (TW)

(21) Appl. No.: 12/852,505

(22) Filed: Aug. 8, 2010

(51) Int. Cl. F16N 3/12; G01F 11/00

(52) U.S. Cl. 222/323; 222/256; 222/324

(57) ABSTRACT

A dual-use type grease gun comprises a grease barrel and an end lid covering the grease barrel. A handle and a press-grip are disposed to a side of the end lid. A movable handgrip is slidably disposed on the press-grip, and a positioning component capable of positioning the movable handgrip is further disposed to the movable handgrip. The moment arm length of the press-grip can be changed to allow a user to select a single hand or both hands for operation by regulating the position of the movable handgrip relative to the press-grip according to different work environments and demands.

### BACKGROUND OF THE INVENTION

1. Field of the Invention

The present invention relates to a grease gun, and more particularly to a dual-use type grease gun operated by a single hand or both hands.

2. Description of the Related Art

A conventional grease gun could be divided into a both-hand operated grease gun and a single-hand operated grease gun. As shown in FIG. 9, a conventional single-hand operated grease gun is depicted. The foregoing grease gun is composed of a grease barrel 91, an end lid 92 and a grease injection mechanism 93. The grease barrel 91 is connected to the end lid 92. A handle 94 is fastened to a side of the end lid 92, and an outlet 921, a channel 922 and a through hole 923 are disposed in the end lid 92. The channel 922 respectively communicates with the outlet 921 and the through hole 923. The grease injection mechanism 93 has a pumping rod 931 in the channel 922 of the end lid 92. An end of the pumping rod 931, which is exposed to the channel 922, is pivotally connected to a handgrip 95. The handgrip 95 then is pivotally connected to the handle 94 of the end lid 92 through a connecting lever 96. Accordingly, a user can use a single hand to press the handgrip 95 and links the pumping rod 931 to generate the pushing effect in the channel 922 so that grease pumped from the grease barrel 91 can be discharged toward the outlet 921 of the end lid 92 to achieve the goal of supplying grease.

Although the foregoing grease gun structure operated by the single hand could supply grease through the single hand, the conventional grease gun may be restricted by the point of application and influenced while using the single hand for operation. Consequently, the conventional grease gun is unable to apply to the work environment that needs to supply grease at high pressure.

In addition, as shown in FIG. 10, a conventional both-hand operated grease gun structure. While in use, one hand holds a handgrip 97, and another hand holds a grease barrel body 98 of the grease gun. The grease gun can be easily operated to apply force and satisfy the demand of pumping grease at high pressure through the operation of both hands. The defect is that both hands must simultaneously apply force to perform the motion of pumping grease to cause the inconvenience by comparing with the grease gun operated by the single hand.

### SUMMARY OF THE INVENTION

In view of the shortcomings of the prior art, the inventor(s) of the present invention based on years of experience in the related industry to conduct extensive researches and experiments, and finally developed a dual-use type grease gun.

Therefore, it is a primary objective of the present invention to overcome the aforementioned shortcoming and deficiency of the prior art by providing a dual-use type grease gun that is operated by a single hand or both hands so that a user could select the most appropriate operating mode based upon different work environments and demands.

To achieve the foregoing objectives, a dual-use type grease gun provided by the invention comprises a grease barrel for filling grease; an end lid connected to the grease barrel, wherein a side of the end lid is connected to a handle, and a channel, an outlet and a through hole are disposed in the end lid; a press-grip pivoted on the end lid, wherein a pumping rod correspondingly passing through the channel of the end lid is further pivoted to the press-grip, and the pumping rod is linked by the press-grip to perform a horizontal straight line motion in the channel so that a pushing effect is generated to discharge grease from the outlet of the end lid; a movable handgrip slidably disposed to the press-grip and axially sliding along the press-grip, a positioning component disposed to the movable handgrip, the positioning component correspondingly pressing the press-grip to position the movable handgrip.

The cross-section of the movable handgrip is a [symbol] -shape to be correspondingly against an external periphery of the press-grip, and two correspondingly side walls of the movable handgrip, which are higher than the press-grip, are respectively provided with two piercing holes. The positioning component has a base, and the base has two connection holes corresponding to the two piercing holes. Two blocking components respectively pass through the piercing holes and the connection holes to position the base, and the two blocking components are located at side edges of the press-grip that are toward the handle. A screw hole is further disposed to an end surface of the base that is toward the press-grip, and the screw hole is located between the two connection holes. A screw rod passes through the base through the screw hole, and an end of the screw rod is connected to a pressing member that is relatively disposed to an inner edge of the press-grip through an E-shaped buckle, and the pressing member is driven to press the inner edge of the press-grip to position the movable handgrip by rotably locking the screw rod on the base.

### BRIEF DESCRIPTION OF THE DRAWINGS

FIG. 1 is a three-dimensional decomposition chart according to the present invention;

FIG. 2 is a cross-sectional drawing of an assembled dual-use type grease gun according to the present invention;

FIG. 3 is a schematic diagram of using a single hand to operate the dual-use type grease gun according to the present invention;

FIG. 4 is a schematic diagram of a buckle ring hooking an external periphery of a movable handgrip according to the present invention;

FIG. 5 is a schematic diagram of releasing a screw rod of a positioning component according to the present invention;

FIG. 6 is a schematic diagram of a state of the movable handgrip after it slides and is positioned;

FIG. 7 is a schematic diagram of using both hands to operate the dual-use type grease gun according to the present invention;

FIG. 8 is a structural drawing in accordance with a second embodiment of the present invention;

FIG. 9 is a schematic diagram of using a single hand to operate a conventional grease gun; and

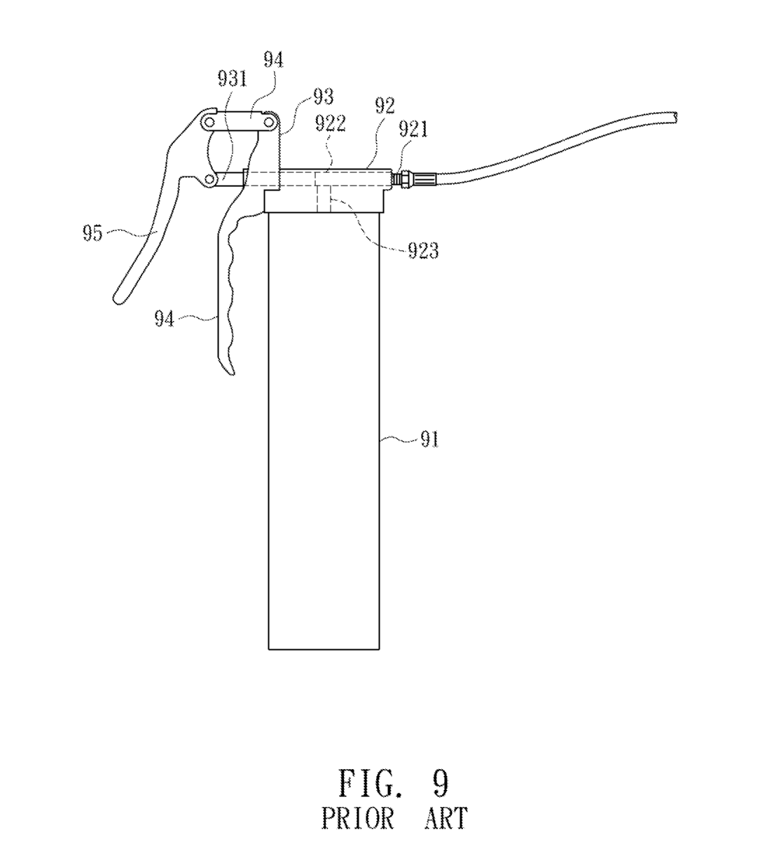

FIG. 10 is a schematic diagram of using both hands to operate the conventional grease gun.

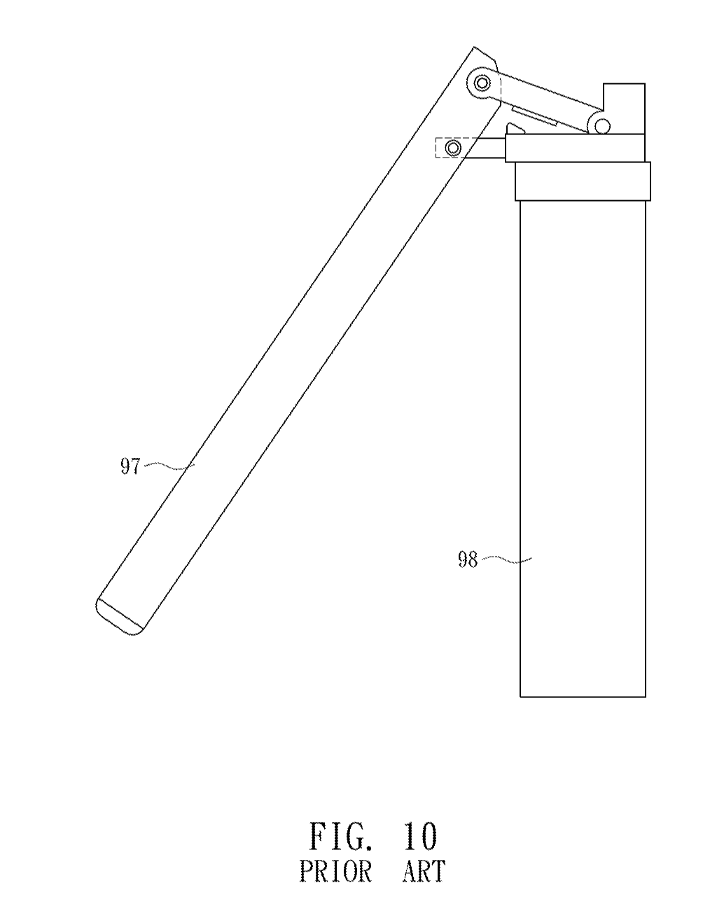

### DETAILED DESCRIPTION OF THE PREFERRED EMBODIMENTS

The foregoing and other technical characteristics of the present invention will become apparent with the detailed description of the preferred embodiments and the illustration of the related drawings.

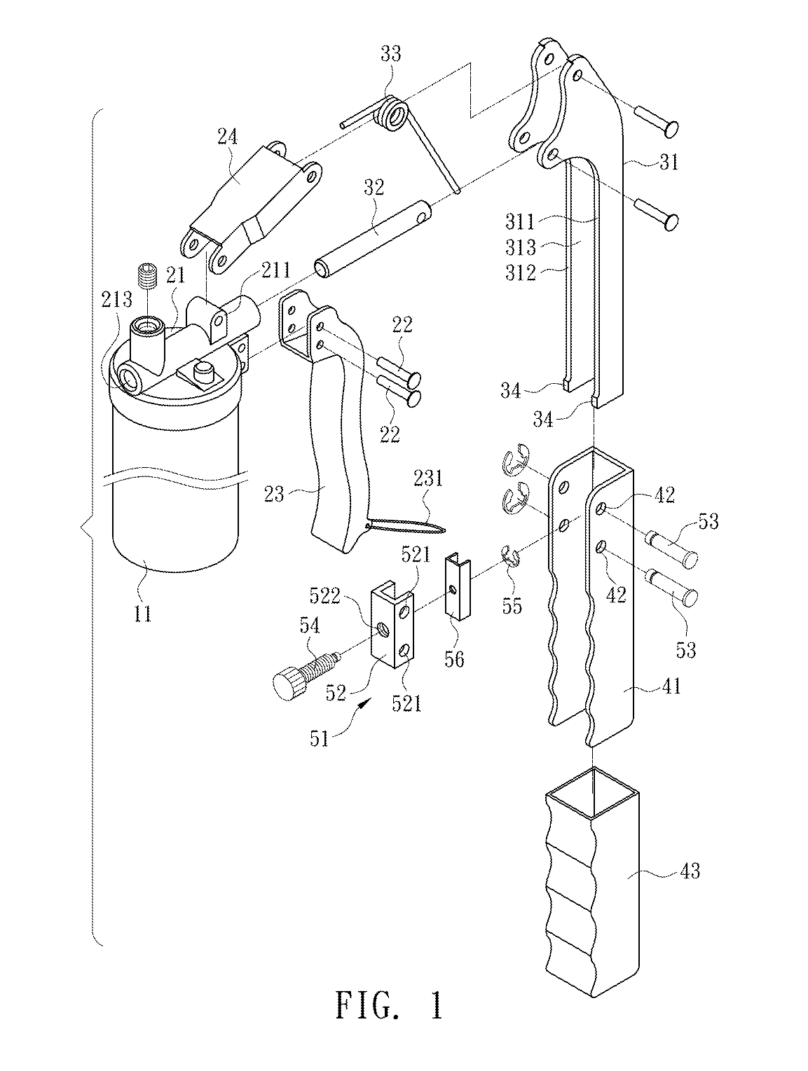

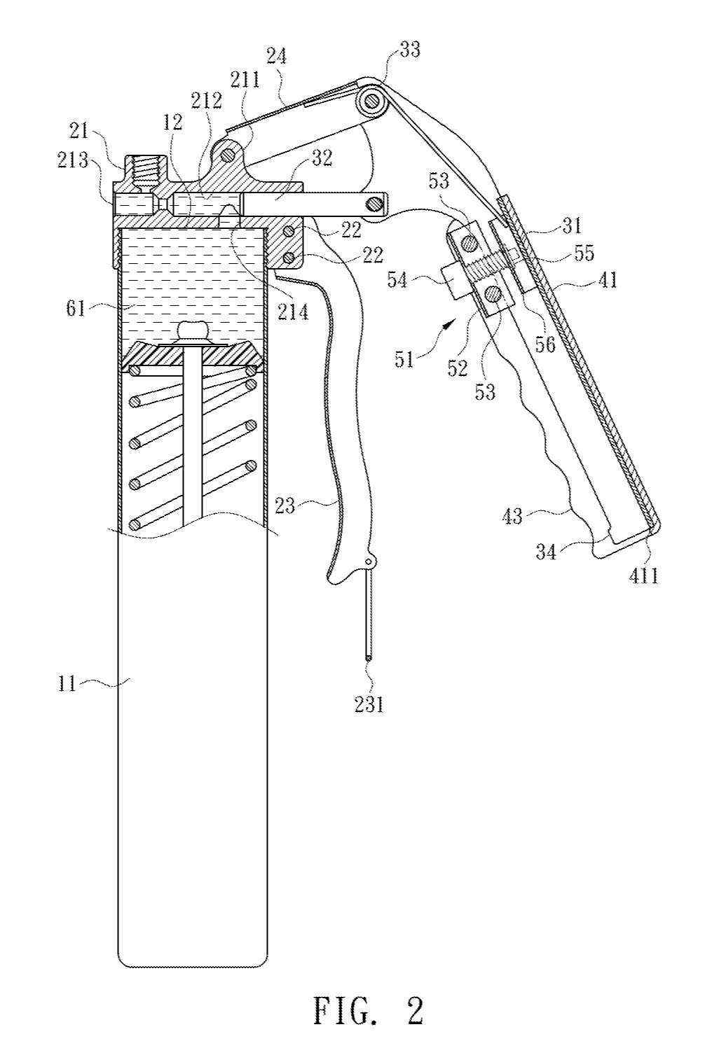

With reference to FIG. 1 to FIG. 2 for a dual-use type grease gun in accordance with the present invention, the grease gun is composed of a grease barrel 11, an end lid 21, a press-grip 31 and a movable handgrip 41.

The grease barrel 11 is a hollow barrel body having an opening end 12, and the inside of the grease barrel 11 is filling with grease 61. The end lid 21 is disposed on the opening end 12 of the grease barrel 11, and a side of an external portion of the end lid 21 is connected to a handle 23 passed by several positioning members 22. A snap ring 231 is pivotally disposed to an end of the handle 23. A pivot portion 211 is protruded from a top portion of the end lid 21. An end of a towing component 24 is pivotally connected to the pivot portion 211. A channel 212, an outlet 213, and a through hole 214 are formed in the end lid 21. The channel 212 respectively communicates with the outlet 213 and an end of the through hole 214. Another end of the through hole 214 communicates with an inside of the grease barrel 11.

A cross-section of the press-grip 31 is a [symbol] -shape having two side walls 311, 312 corresponding to each other. A containing space 313 is formed between the two side walls 311, 312. A top portion of the press-grip 31 is pivotally connected to another end of the towing component 24 pivoted on the end lid 21 to relatively locate at a side of the handle 23, and a pumping rod 32 correspondingly passing through the channel 212 is pivoted to a side of the press-grip 31 that is toward the channel 212 of the end lid 21. The pumping rod 32 is linked by the press-grip 31 to perform the reciprocating motion in the channel 212 so as to control the communicating state of the through hole 213 and the channel 212 of the end lid 21. In addition, a torsion spring 33 is disposed between the towing component 24 and the press-grip 31. An end of the torsion spring 33 leans against a bottom of the towing component 24, and another end of the torsion spring 33 leans against an inner edge wall of the press-grip 31 so that the press-grip 31 can be kept at a state of outward release without imposing external force. A limit portion 34 is protruded from an end of the press-grip 31 that is toward a side of the through hole 214 of the end lid 21.

The movable handgrip 41 is fit with the press-grip 31 and axially slides on the press-grip 31. A positioning component 51 is disposed to the movable handgrip 41, and the positioning component 51 could correspondingly lean against the press-grip 31 to position the movable handgrip 41. In the embodiment, a cross-section of the movable handgrip 41 is a [symbol] -shape and uses its inner peripheral surface leaning against an external periphery of the press-grip 31 to slide relative to the press-grip 31. A stopping portion 411 is formed by inwardly bending an end of the movable handgrip 41. The stopping portion 411 slides in accordance with the movable handgrip 41 to mutually connect the end of the press-grip 31. The stopping portion 411 of the movable handgrip 41 is stopped by the end of the press-grip 31 to restrict the sliding stroke of the movable handgrip 41. Two correspondingly side walls of the movable handgrip 41, which are higher than the press-grip 31, are respectively provided with two piercing holes 42 that are higher than two correspondingly side walls of the press-grip 31. The positioning component 41 has a base 52. The base 52 has two connection holes 521 corresponding to the two piercing holes 42, and two blocking components 53 respectively pass through the correspondingly piercing holes 42 and the connection holes 521 to position the base 52 in the containing space 313 of the press-grip 31. When the movable handgrip 41 slides relative to the press-grip 31, the base 52 could synchronously slide in accordance with the movable handgrip 41 along the containing space 313 of the press-grip 31, and the two blocking components 53 are located at side edges of the press-grip 31 that is toward the handle 23. Accordingly, when a top portion of the movable handgrip 41 slides down the end of the press-grip 31, the blocking components 53 at the movable handgrip 41 is further blocked by the limit portion 34 at the end of the press-grip 31 so that the movable handgrip 41 may not come off the end of the press-grip 31. A screw hole 522 is further disposed to an end surface of the base 52 that is toward the press-grip 31, and the screw hole 522 is located between the two connection holes 521. A screw rod 54 passes through the base 52 through the screw hole 522, and an end of the screw rod 54 is connected to a pressing member 56 that is relatively disposed to an inner edge of the press-grip 31 through an E-shaped buckle 55, and the pressing member 56 is driven to shift toward the inner edge of the press-grip 31 by rotably locking the screw rod 54 on the base 52. When the pressing member 56 correspondingly presses the correspondingly inner edge walls of the press-grip 31, the movable handgrip 41 can be positioned. A handling member 43 composed of a soft material (e.g. plastic or rubber) is fit to an external periphery of the movable handgrip 41 so that a user can easily hold and operate the movable handgrip 41.

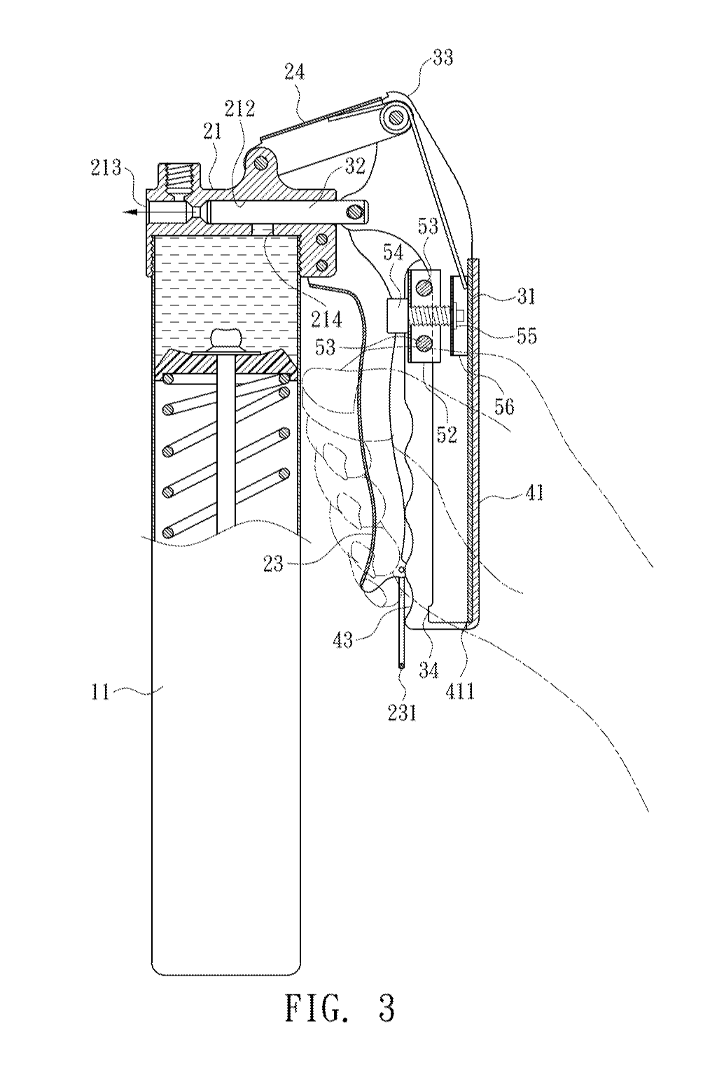

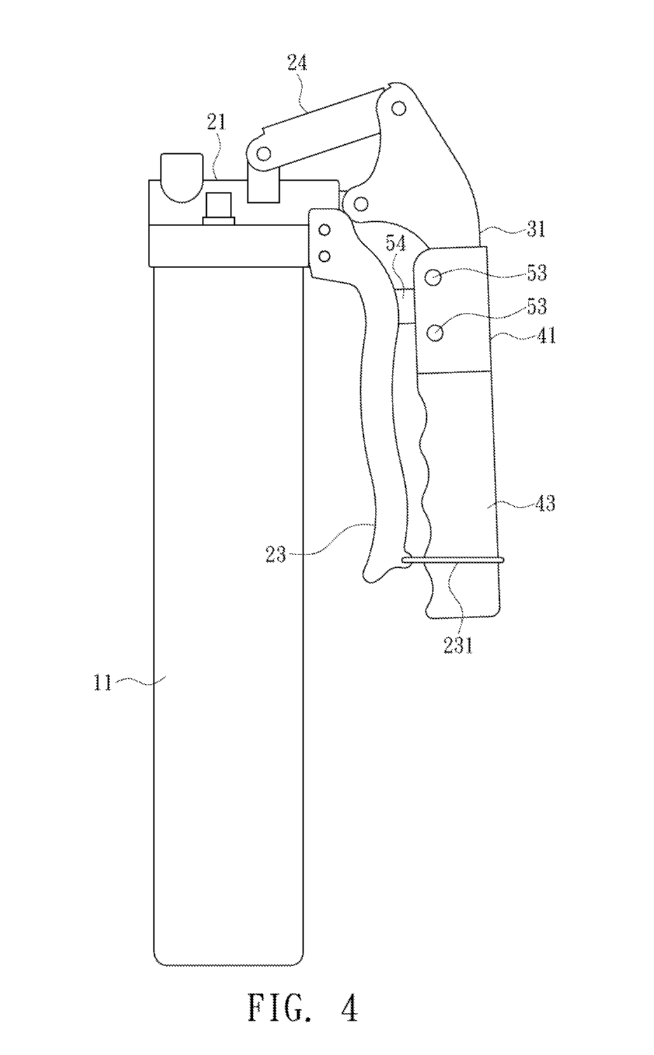

When the invention is operated by a single hand, as shown in FIG. 3, the movable handgrip 41 is fit to the press-grip 31, and the stopping portion 411 of the movable handgrip 41 mutually leans against the end of the press-grip 31. At this time, an operator only uses fingers to hook the handle 23 and then uses a palm to impose force to repeatedly press the movable handgrip 41 fit on the external periphery of the press-grip 31 so that the pumping rod 32 is linked to perform the reciprocating motion in the channel 212 of the end lid 21, and a pushing effect is generated in the channel 212. Grease pumped from the through hole 214 of the end lid 21 is pushed by the pumping rod 32 and then is discharged from the outlet 213 of the end lid 21. Therefore, the motion of supplying grease can be easily completed by using a single hand. Moreover, as shown in FIG. 4, when the invention is not in use, the snap ring 231 disposed to the handle 23 hooks the external periphery of the movable handgrip 41 so that the press-grip 31 and the movable handgrip 41 are retained at the pressing position to allow the pumping rod 32 to seal the through hole 214 to prevent grease from leaking, and the timber volume of the invention can be effectively reduced while in storing state.

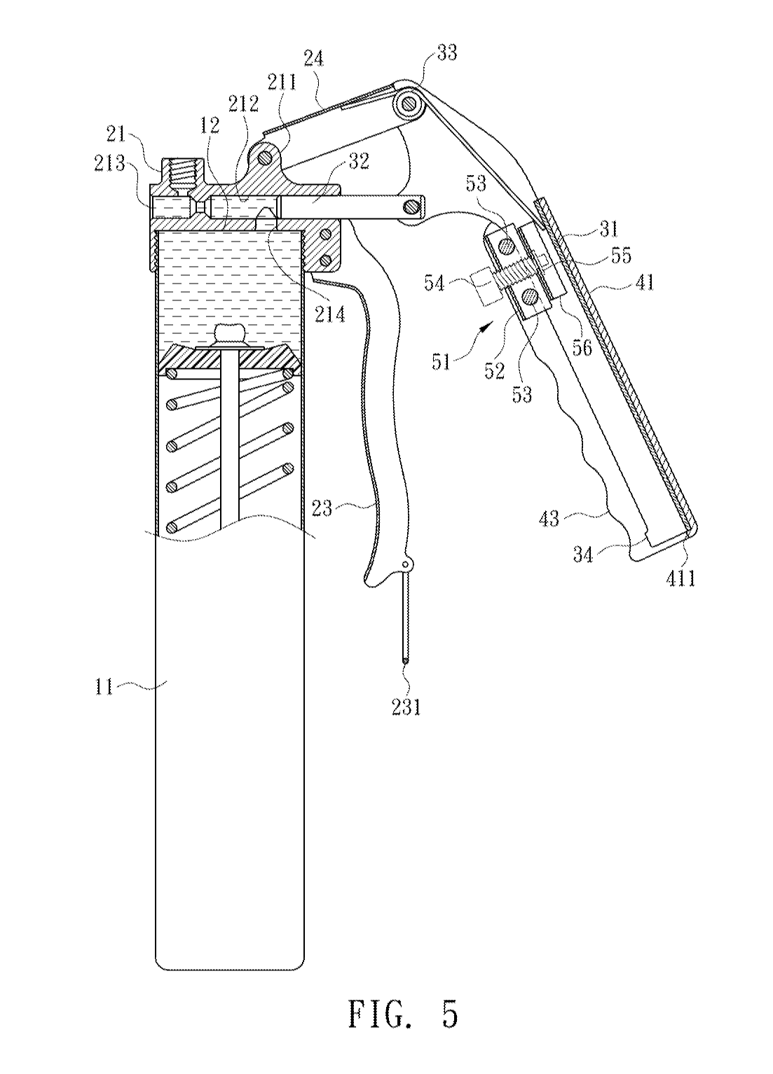

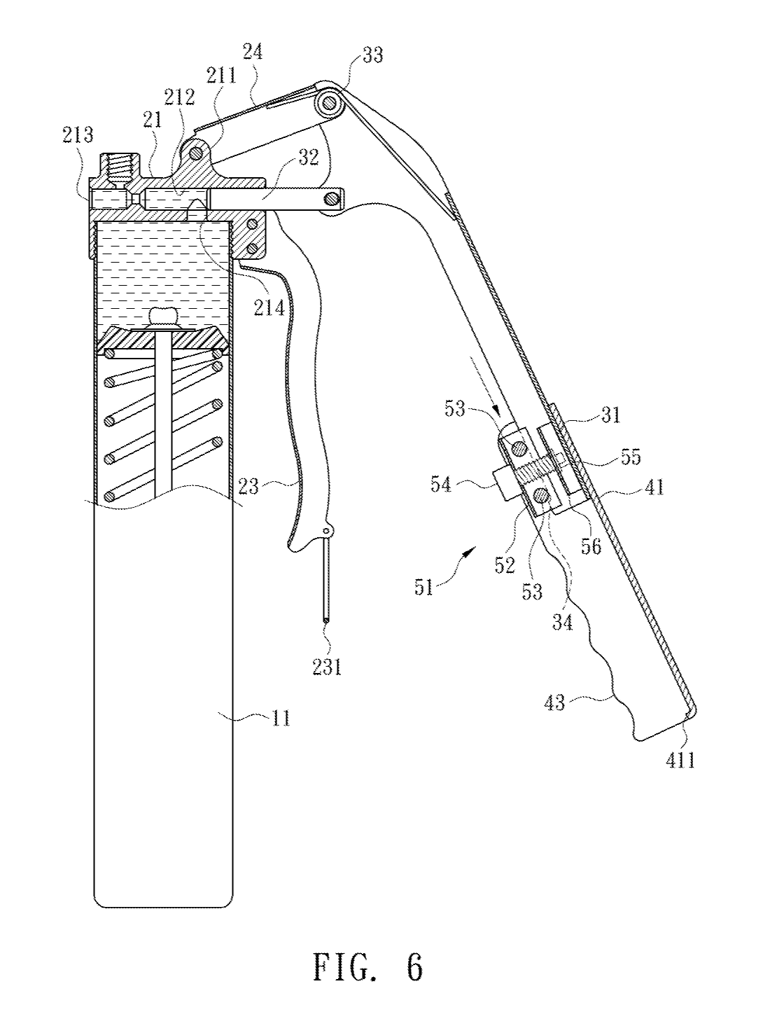

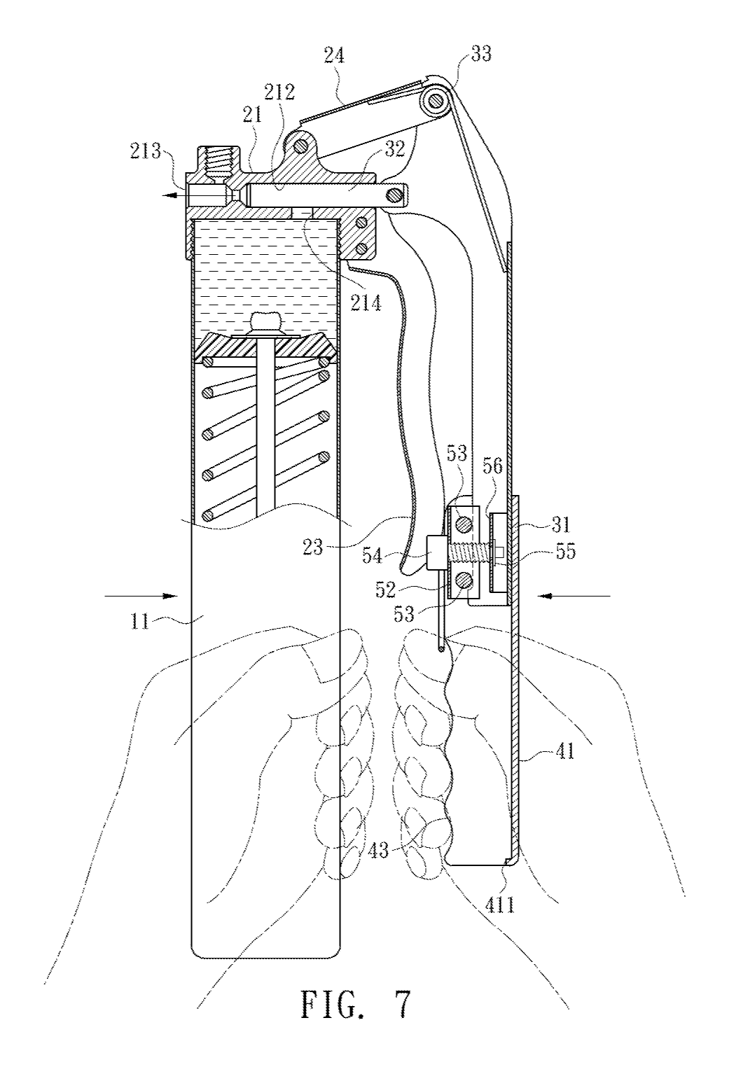

In the work environment that needs to supply grease at high pressures, as shown in FIG. 5, the operator only needs to release the screw rod 54 of the positioning component 51 so that the pressing member 56 connected by the end of the screw rod 54 does not lean against the inner edge wall of the press-grip 31, and the positioning state of the movable handgrip 41 can be relatively released to allow the movable handgrip 41 axially sliding along the external periphery of the press-grip 31 as shown in FIG. 6. When the top portion of the movable handgrip 41 slides down the end of the press-grip 31, the screw rod 54 of the positioning component 51 is tightly rotated to position the movable handgrip 41 at the slid position. Accordingly, the moment arm length of the press-grip 31 can be increased so that the operator uses one hand to hold the grease barrel 11 and another hand to hold the handling member 43 of the movable handgrip 41 to perform the operation mode easily forced by both hands, thereby satisfying the demand of supplying grease at high pressure (as shown in FIG. 7).

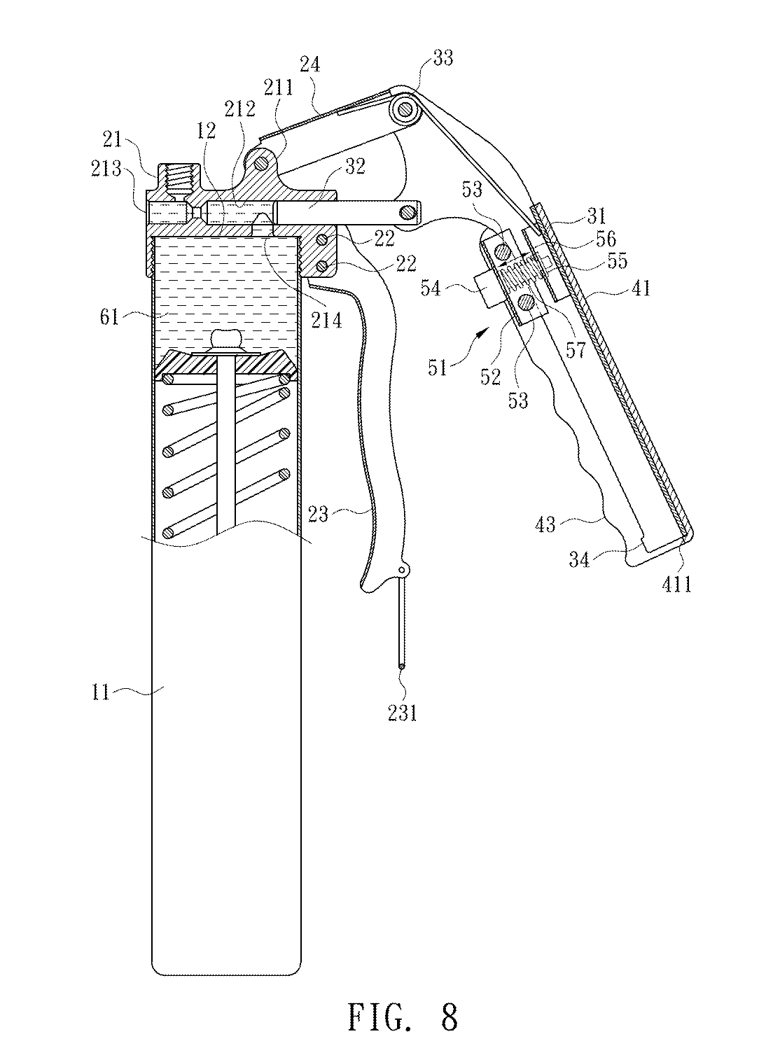

With reference to FIG. 8 for a second embodiment in accordance with the present invention, by comparing with the forgoing embodiment, the difference is that an elastic member 57 is further fit to the screw rod 54 of the positioning component 51. An end of the elastic member 57 leans against the base 52, and another end of the elastic member 57 leans against the pressing member 56. Accordingly, an axial reactive force is additionally provided to the screw rod 54 so that the screw rod 54 may not easily come off.

The invention composed of the foregoing components has the following advantages:
1. The structure of the invention is simple to have features of easy installation and low manufacturing cost.
2. The invention can be operated by a single hand or both hands to allow the operator to select the most appropriate operation manner based upon different work environments and demands.
3. By rotably locking the screw rod on the base, the invention could drive the pressing member, which is connected by the screw rod, to press the inner edge wall of the press-grip to achieve the efficacy of rapidly positioning the position of the movable handgrip so as to have features of easy and fast operation.
4. When the stopping portion at the end of the movable handgrip is stopped by the end of the press-grip and when the top portion of the movable handgrip slides down the end of the press-grip, the blocking components of the movable handgrip is blocked by the limit portion at the end of the press-grip to effectively restrict the sliding stroke of the movable handgrip, and the sliding motion performed by the movable handgrip of the invention can be more convenient and accurate.

5. The invention further has an elastic member fit to the screw rod of the positioning component. An end of the elastic member leans against the base, and another end of the elastic member leans against the pressing member to additionally provide an axial reactive force to the screw rod so that the screw rod may not easily come off.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A dual-use type grease gun comprising:
a grease band for filling grease;
an end lid connected to the grease barrel, wherein a side of the end lid is connected to a handle, and a channel, an outlet and a through hole are disposed in the end lid;
a press-grip pivoted on the end lid, wherein a pumping rod correspondingly passing through the channel of the end lid is further pivoted to the press-grip, and the pumping rod is linked by the press-grip to perform a horizontal straight line motion in the channel so that a pushing effect is generated to discharge grease from the outlet of the end lid;
a movable handgrip slidably disposed to the press-grip and axially sliding along the press-grip, a positioning component disposed to the movable handgrip, the positioning component correspondingly pressing the press-grip to position the movable handgrip.

2. The dual-use type grease gun as recited in claim 1, wherein a pivot portion is protruded from a top portion of the end lid, and an end of the towing component is pivotally connected to the pivot portion, and a top portion of the press-grip is pivotally connected to another end of the towing component pivoted to the end lid and relatively located at a side of the handle.

3. The dual-use type grease gun as recited in claim 2, wherein a torsion spring is disposed between the towing component and the press-grip, and an end of the torsion spring leans against a bottom of the towing component, and another end of the torsion spring leans against an inner edge wall of the press-grip.

4. The dual-use type grease gun as recited in claim 1, wherein a cross-section of the movable handgrip is a [symbol] -shape to be correspondingly against an external periphery of the press-grip, and two correspondingly side walls of the movable handgrip, which are higher than the press-grip, are respectively provided with two piercing holes, and the positioning component has a base, and the base has two connection holes corresponding to the, two piercing holes, and two blocking components respectively pass through the piercing holes and the connection holes to position the base, and the two blocking components are located at side edges of the press-grip that are toward the handle, and a screw hole is further disposed to an end surface of the base that is toward the press-grip, and the screw hole is located between the two connection holes, and a screw rod passes through the base through the screw hole, and an end of the screw rod is connected to a pressing member that is relatively disposed to an inner edge of the press-grip through an E-shaped buckle, and the pressing member is driven to press the inner edge of the press-grip to position the movable handgrip by rotably locking the screw rod on the base.

5. The dual-use type grease gun as recited in claim 4, wherein a cross-section of the press-grip is a [symbol] -shape to have two side walls corresponding to each other, and a containing space is formed between the two side walls, and the base, which is passed by the two blocking components, is positioned on the movable handgrip and in the containing space, and when the movable handgrip slides relative to the press-grip, the base synchronously slides in accordance with the movable handgrip along the containing space of the press-grip.

6. The dual-use type grease gun as recited in claim 4, wherein a limit portion is further protruded from an end of the press-grip that is toward a side of the through hole of the end lid, and when the movable handgrip slides down the end of the press-grip, the blocking components on the movable handgrip are blocked by the limit portion at the end of the press-grip.

7. The dual-use type grease gun as recited in claim 4, wherein an elastic member is fit to the screw rod of the positioning component; and an end of the elastic member leans against the base, and another end of the elastic member leans against the pressing member.

8. The dual-use type grease gun as recited in claim 1, wherein a stopping portion is formed by inwardly bending an end of the movable handgrip, and the stopping portion slides in accordance with the movable handgrip to mutually connect the end of the press-grip.

9. The dual-use type grease gun as recited in claim 1, wherein an external periphery of the movable handgrip is fit with a handling member composed of a soft material.
